(19) United States
(12) Patent Application Publication
(10) Pub. No.: US 2026/0194375 A1
(43) Pub. Date: Jul. 9, 2026

(54) ADJUSTABLE SCROLL TARGET SYSTEM FOR VEHICLE SENSOR CALIBRATION

(71) Applicant: BPG Sales and Technology Investments, LLC, Shelby Township, MI (US)

(72) Inventor: Jon D. Lawrence, Williamsburg, MI (US)

(21) Appl. No.: 19/443,559

(22) Filed: Jan. 8, 2026

Related U.S. Application Data
(60) Provisional application No. 63/743,002, filed on Jan. 8, 2025.

(51) Int. Cl. G01D 18/00; G01M 11/00

(52) U.S. Cl. CPC G01D 18/00; G01M 11/30

(57) ABSTRACT

A sensor target system for aligning sensors equipped on a vehicle with calibration targets comprising a vehicle support stand configured to selectively hold a vehicle, a moveable web having a plurality of targets disposed thereon, wherein the moveable web is disposed adjacent the vehicle support stand such that targets are oriented to face upwards, and where the web is moveable to selectively position one of the targets into a preselected position for calibration of a sensor of a vehicle on the vehicle support stand. A method for aligning a target to a sensor on an equipped vehicle includes positioning a vehicle into a known orientation and moving an upwardly oriented selected target into a calibration position adjacent the vehicle, where the selected target is disposed on a web of a plurality of targets.

### CROSS REFERENCE TO RELATED APPLICATION

The present application claims the priority benefit of U.S. Provisional Patent Application Ser. No. 63/743,002, filed on Jan. 8, 2025, which is incorporated herein by reference in its entirety.

### BACKGROUND AND FIELD OF THE INVENTION

The present invention is directed to a vehicle sensor calibration system and method, and in particular to a system and method for orienting targets for sideview cameras, such as surround view cameras, on a vehicle.

The use of radar, imaging systems, and other sensors, such as LIDAR, ultrasonic, and infrared (IR) sensors, to determine range, velocity, and angle (elevation or azimuth) of objects in an environment are important in a number of automotive safety systems, such as an Advanced Driver Assistance System (ADAS) for a vehicle. A conventional ADAS system will utilize one or more sensors. While these sensors are aligned and/or calibrated by the manufacturer on the assembly line (or at another time or another facility), the sensors may need realignment or recalibration periodically, such as due to the effects of wear and tear, or misalignment due to driving conditions or through mishap, such as an accident. Furthermore, such an ADAS system may comprise one or more subsystems, e.g., adaptive cruise control (ACC), lane departure warning (LDW), parking assistance, and/or a rear-view camera, each of which may periodically require individual realignment or recalibration

### SUMMARY OF THE INVENTION

The present invention provides a method and system for aligning and/or calibrating a vehicle equipped sensor by aligning the vehicle and one or more calibration targets whereby sensors on the vehicle may be calibrated. The system includes one or more targets disposed on reels via which a selected target may be positioned depending on the particular vehicle sensor requiring calibration.

According to an aspect of the present invention, a sensor target system for aligning sensors equipped on a vehicle with calibration targets comprises a vehicle support stand configured to selectively hold a vehicle, a moveable web having a plurality of targets disposed thereon, where the moveable web is disposed adjacent the vehicle support stand such that the targets are oriented to face upwards, and where the web is moveable to selectively position one of the targets into a preselected position for calibration of a sensor of a vehicle on the vehicle support stand.

In a particular embodiment, the web is flexible. Still further, the system may comprise a pair of reels about which the web is disposed with a planar section of the web spanning between the reels, where the reels are selectively rotated for movement of the web. The web may be configured to be selectively unwound from one reel and wound on the other reel for movement in one direction. The system may include one or more encoders for monitoring the rotation of one or both reels.

In the illustrated embodiment the web is horizontally oriented whereby the targets are oriented to face upwards. In a particular configuration the web is moveable in a longitudinal and/or lateral direction relative to a vehicle disposed on the vehicle support stand. The web may be supported by one or more actuators for movement of the web relative to the vehicle support stand. In a particular configuration the web may have an elongate length with an actuator configured to move the web perpendicularly relative to the elongate length for lateral movement of the web.

In a still further embodiment, the system may include webs disposed on either side of the support stand with elongate lengths of the webs extending parallel to a longitudinal axis of a vehicle disposed on the vehicle support stand. In such an embodiment both webs may comprise moveable webs that each have a plurality of targets disposed thereon and are oriented to face upwards.

In any of the various embodiments the vehicle support stand may comprise a vehicle positioning assembly for orienting a vehicle into a known orientation. Also in any of the various embodiments the system may include a moveable target adjustment frame positioned forward of the vehicle support stand and configured to hold another target, with the system further comprising a rail for longitudinal movement of the target adjustment frame toward and away from the vehicle disposed on the support stand. Alternatively, the system may comprise a moveable robot configured to hold a target and being positioned forward of the vehicle support stand, and comprising a track along which the robot is configured to move toward and away from the vehicle disposed on the support stand.

The present system enables accurate alignment of vehicles and their equipped sensors for calibration of the sensors, and in particular readily enables the presentment and alignment of floor oriented targets, such as for sensors disposed on the sides of a vehicle. These and other objects, advantages, purposes and features of this invention will become apparent upon review of the following specification in conjunction with the drawings.

### BRIEF DESCRIPTION OF THE DRAWINGS

FIG. 1 is a top view of a vehicle alignment and sensor calibration system in accordance with the present disclosure;

FIG. 2 is a side view of the system of FIG. 1;

FIG. 3 is an end view of the system of FIG. 1;

FIGS. 4-8 disclose an embodiment of a vehicle locating assembly in accordance with the present disclosure;

FIGS. 9-10 disclose an embodiment of a target adjustment frame in accordance with the present disclosure; and

FIG. 11 discloses an alternative embodiment employing a robotic target holder.

### DESCRIPTION OF THE PREFERRED EMBODIMENTS

The present invention will now be described with reference to the accompanying figures, wherein the numbered elements in the following written description correspond to like-numbered elements in the figures.

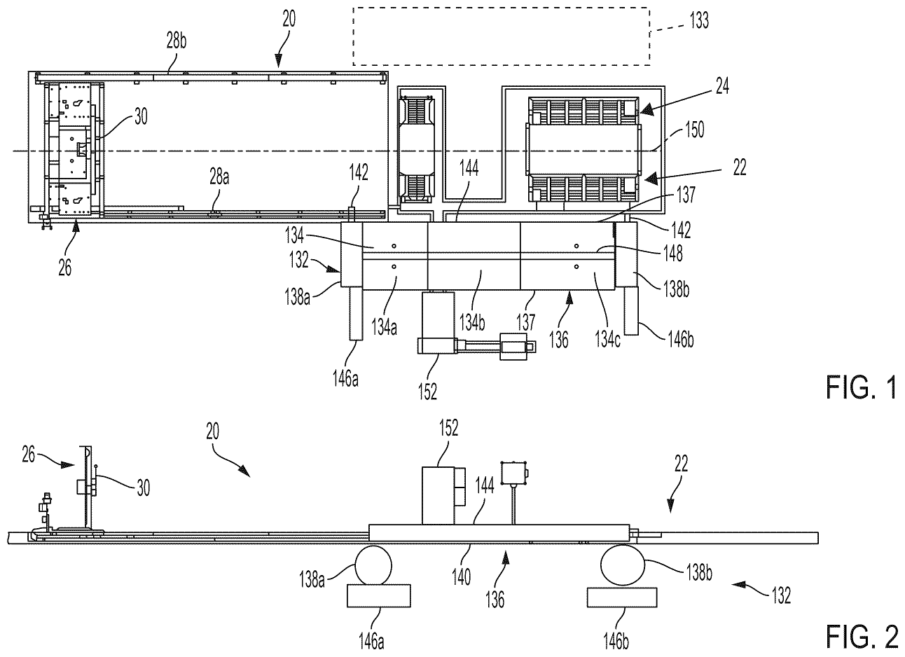

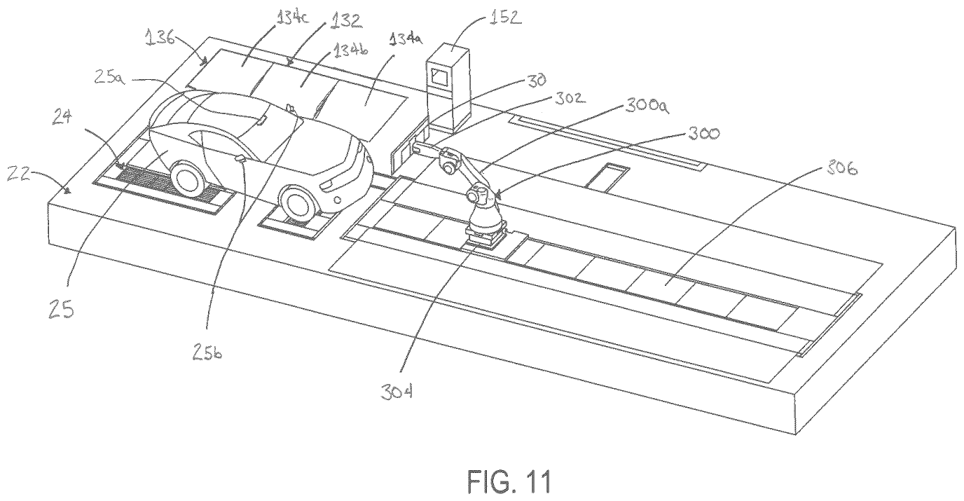

FIG. 1 illustrates an exemplary vehicle alignment and sensor calibration target system 20 in accordance with present disclosure. Sensor target system 20 includes a vehicle support stand 22 that includes a vehicle locating assembly 24 on which a vehicle 25 (FIG. 11) is stationarily positioned for calibrating sensors of the vehicle, such as sensors that are part of one or more subsystems of an exemplary Advanced Driver Assistance System (ADAS) of the vehicle. Sensors may thus be radar sensors for adaptive cruise control (“ACC”), imaging systems such as camera sensors for lane departure warning (“LDW”) and other ADAS camera sensors disposed about vehicle, as well as other sensors, such as radar, LIDAR, ultrasonic, and infrared (“IR”) sensors of an ADAS system, including sensors mounted inside the vehicle, such as forward facing cameras 25a or exterior mounted sensors 25b (FIG. 11), such as a camera mounted to a sideview mirror. System 20 additionally includes a target adjustment stand or frame 26 movably mounted on rails 28a, 28b for selectively positioning the target adjustment frame 26 longitudinally relative to a vehicle 25 on support stand 22. Target adjustment frame 26 is configured to hold and position one or more targets 30 for use in calibrating the sensors of the vehicle. Still further, system 20 includes a horizontal sensor target system 132 that is operable to selectively present one or more of various targets 134 (such as 134a, 134b, 134c as shown) disposed on a flexible belt or web 136, where web 136 is moveable relative to support stand 22 to position a given target 134 relative to a vehicle 25 for calibration of a sensor 25b on the vehicle 25. Horizontal sensor target system 132 is useable for various sensors, including sensors mounted at sides of a vehicle, such as a camera 25b mounted at a side view mirror for a surround view system on the vehicle 25. As discussed in more detail below, web 136 comprises a flexible material upon which targets 34 are disposed where web 136 is configured to be rolled up along respective rollers or reels 138a, 138b with a planar section 140 disposed therebetween. Web 136 may be selectively spooled between reels 138a, 138b for positioning a selected target, such as one of targets 134a, 134b, 134c, into the proper position for calibration of a given sensor, where the selected target is for specific use with a given sensor 25b on a vehicle 25, such as the specific type of sensor and the vehicle make, model and/or year.

Vehicle support stand 22 may be constructed in like manner to the vehicle support stand disclosed in commonly owned U.S. Pat. No. 11,597,091, which is incorporated herein by reference, including with the vehicle locating assembly 24 being configured in like manner to the wheel support and centering assemblies of U.S. Pat. No. 11,597,091, the configuration of which is discussed in more detail below.

Target adjustment stand 26 may be constructed in like manner to the target adjustment stand disclosed in commonly owned U.S. Pat. No. 11,243,074, which is incorporated herein by reference, including with the regard to the operation of targets stand 26 on the rails 28a, 28b being configured and operating in like manner to the rails of U.S. Pat. No. 11,243,074, the configuration of which is discussed in more detail below. Alternatively, rather than employ a target adjustment stand 26, the present system 20 may employ a moveable robot or robotic manipulator for holding and positioning a target, such as target 30, relative to a vehicle on supports stand 22, as disclosed in the above noted and incorporated U.S. Pat. No. 11,597,091.

In the illustrated embodiment horizontal sensor target system 132 includes a web 136 on which targets 134 are disposed in a horizontal planar manner. Web 136 is elongated and wound on reels 138a, 138b to selectively wind and unwind web 136 relative to its elongate length to enable alternative targets 134a, 134b, 134c to be disposed adjacent the vehicle on support stand 22, where reels 138a, 138b and web 136 are generally configured as a scroll. It should be appreciated that although three targets 134a, 134b, 134c are illustrated in FIG. 1, that web 136 may include numerous such targets. In particular, web 136 may include targets for numerous different sensors associated with numerous different vehicles, such as based on different makes, models and/or years of vehicles. The targets may comprise various patterns and markings that are different from one another, including for use with specific vehicles and/or sensors. In this way, system 20 may be readily used with numerous different vehicles. For example, a particular vehicle may be positioned on support stand 22 and, upon determination of the vehicle, sensor target system 132 may be caused to display a particular individual target 134 specifically required for calibration of a sensor on that specific vehicle. As the web 136 includes a plurality of targets, such as for use with various different vehicles, system 20 may thus be readily used to orient specific required targets for various different vehicles. In the illustrated embodiment web 136 has side edges 137 between which individual targets 134a, 134b, 134c are disposed. Alternatively, more than one target may be positioned between edges 137.

Reels 138a, 138b are motorized to rotate in either a clockwise or counterclockwise orientation relative to that shown in FIG. 2 for selectively positioning a desired target 134 for display adjacent support stand 22, with the rotational axes of reels 138a, 138b being perpendicular to the longitudinal axis of the support stand 22. In this manner reels 138a, 138b may selectively wind and unwind the web 136 as needed. One or both reels 138a, 138b, or another rotational part associated therewith or with sensor target system 132, may additionally include a rotary encoder 142 (FIG. 1) for tracking the rotational orientation of the associated reels 138a, 138b. Using the rotary encoder 142 the position of the web 136 on one or both reels 138a, 138b is coordinated, along with the size of the targets 134 being known, for accurately tracking the relative orientation of targets 134, such as to move web 136 to position a particular target 134b into a desired display or calibration position 144, such as based on the given vehicle on support stand 22 as discussed in more detail below. As required, web 136 may additionally or alternatively be manually adjusted, such as by an operator, to locate targets 134. In one embodiment, for example, web 136 is initially positioned via motorized reels 138a, 138b, with an operator providing manual positioning for fine adjustment of web 134. Reels 138a, 138b may alternatively be configured for manual, non-motorized rotation.

Sensor target system 132 additionally includes lateral actuators 146a, 146b on which reels 138a, 138b are rotatably mounted for selectively laterally adjusting the longitudinal axis 148 of web 136 relative to support stand 22, such as relative to a longitudinal axis 150 of the vehicle locating assembly 24. Lateral actuators 146a, 146b are motorized and include positional encoders and/or the motorized operation of the actuators 146a, 146b may be monitored for accurately controlling the lateral position of the web 136 relative to the support stand 22. It should be appreciated that different sensors on different vehicles may require different lateral positioning relative to the vehicle, and that different vehicles will have different widths. Lateral actuators 146a, 146b may be variously configured within the scope of the present disclosure. For example, the actuators may comprise various types of linear actuators, including rails, screws, plates, hydraulic or pneumatic actuators, or the like. And although shown as comprising two lateral actuators 146a, 146b in the illustrated embodiment system 20 may alternatively employ a single lateral actuator for laterally moving both reels 138a, 138b.

System 20 additionally includes a controller 152 that comprises a computer system for controlling operation of one or more of vehicle locating assembly 24, target adjustment frame 26 and sensor target system 132. Controller 152 may operate to receive vehicle data information regarding a given vehicle on support stand 22, for example, such as by way of an operator entering it into a user interface of controller 152, or by scanning a bar code, or by reading from an onboard diagnostic system of the vehicle. The vehicle data may comprise the VIN, and/or may comprise the make, model and/or year of the vehicle, and/or may comprise details regarding the particular sensors equipped on the vehicle, or the like.

With the vehicle located and centered via vehicle locating assembly 24, the sensors on the vehicle are in a known location for calibration based on their assembly position on the vehicle. Based on the vehicle data information, controller 152 may direct sensor target system 132 to position a given target 134b into calibration position 144, including laterally moving web 136 relative to longitudinal axis 150 via actuators 146a, 146b for positioning the target 134b into the calibration position 144 based on the vehicle on support stand 22. A calibration routine may then be run for calibrating the sensor, such as an original equipment manufacturer (OEM) calibration routine.

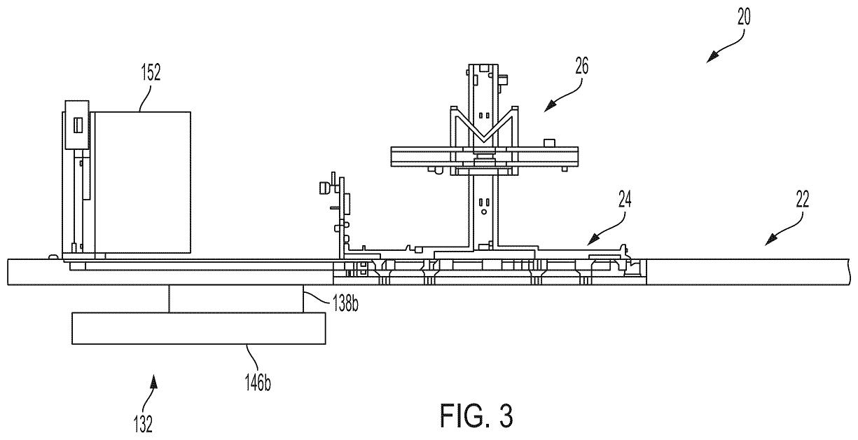

Although shown as including web 136 that is wound on reels 138a, 138b and operating in the manner of a scroll, in an alterative embodiment a web may be configured as an endless belt or web that is disposed about rollers or reels whereby there is an upper section that is disposed and displayed adjacent a vehicle on the support stand 22 and a lower return section parallel to and spanning between such rollers. Moreover, although web 136 and reels 138a, 138b are configured in the illustrated embodiment for movement of web 136 longitudinally relative to support stand 22 and thus parallel to a longitudinal axis of a vehicle 25, in an alternative arrangement the web and reels may be oriented differently. For example, a web and reels may be oriented whereby the web 136 is selectively rotated in a perpendicular orientation relative to support stand 22. That is, the rotational axes of such reels may be parallel to the longitudinal axis of the support stand 22. Still further, although a single scrolled web 136 is illustrated in FIGS. 1-3, it should be understood that additional webs may be provided for with in alternative embodiments of a sensor target system in accordance with the present invention. This could include one or more additional scrolled webs having one or more targets thereon mounted in front, behind or adjacent the illustrated web 136. For example, a series of webs may be provided forward of the illustrated web 136 that may be moved into place or may be wound about an aft mounted reel. Or adjacent webs disposed on additional reels may be moved into position via actuators, such as actuators 146a, 146b. Still further, in yet another alternative embodiment, a web having multiple targets may be moved without the use of reels. For example, the web itself may be longitudinally shifted back and forth to orient desired targets.

Although a single sensor target system 132 is shown in FIG. 1-3, it should be appreciated that system 20 may include multiple such sensor target systems. In particular, a second sensor target system 132 may be disposed on the opposite side of support stand 22 for use with vehicle sensors mounted at the opposite side of vehicle 25, such as mounted in the opposite sideview mirror, such as illustrated at 133 in FIG. 1. Such an additional sensor target system 133 may be constructed substantially similar to target system 132 discussed above. The system may also allow simultaneous calibration of sensors disposed on opposite side of vehicle 25. Still further, a sensor target system that is configured similarly to target system 132 may optionally also be positioned behind support stand 22, such as for use with a rear mounted camera, where such a rear sensor target system would include a web that is configured to be spooled in an orientation that is perpendicular to the longitudinal orientation of the vehicle 25 on the support stand 22. In addition, a sensor target system may be provided in front of support stand 22 with a web configured to be spooled in an orientation that is perpendicular to the longitudinal orientation of the vehicle 25 on the support stand 22.

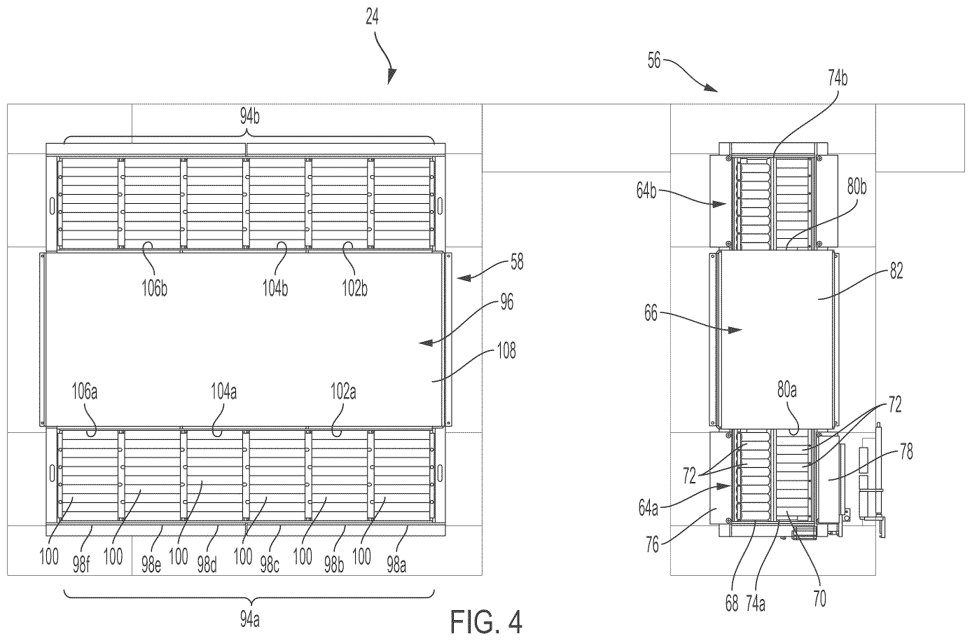

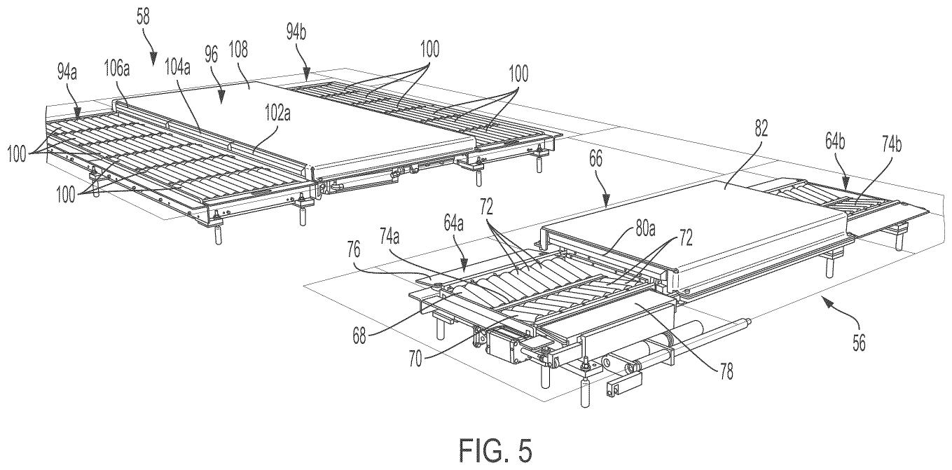

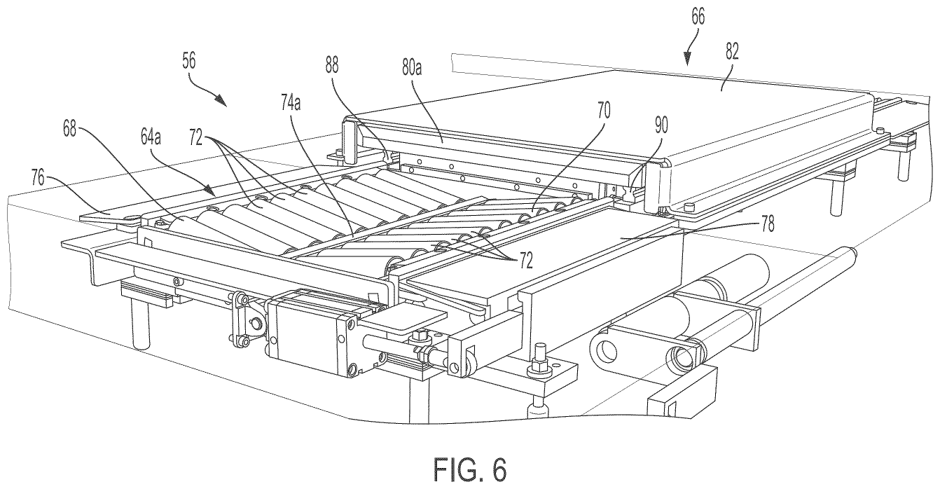

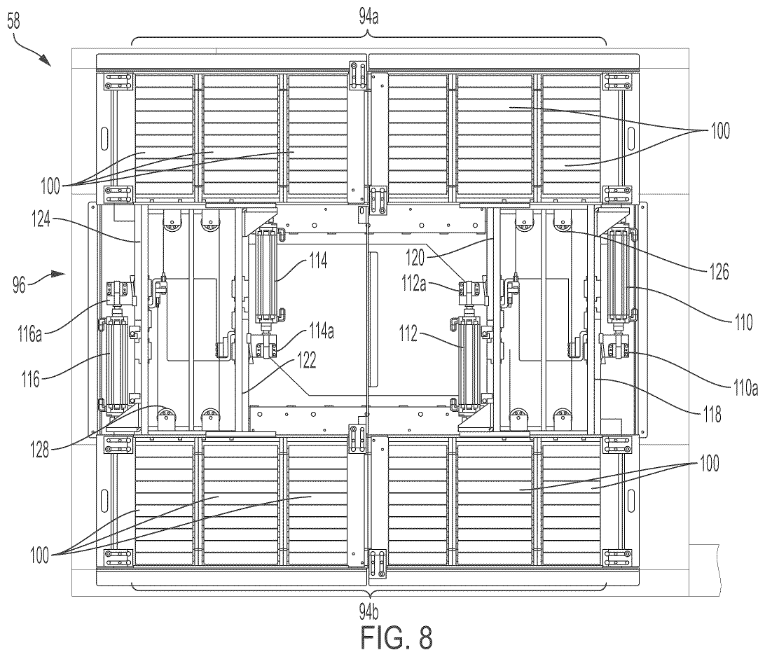

In general, with reference to FIGS. 4-8 and as disclosed in U.S. Pat. No. 11,597,091, vehicle locating assembly 24 comprises a vehicle locating and centering assembly upon which a vehicle is disposed for positioning or orienting the vehicle. In the illustrated embodiment assembly 24 includes a forward wheel support and centering assembly 56 and a rearward wheel support and centering assembly 58 upon which a vehicle is disposed for positioning or orienting vehicle 25. The front wheel assemblies of a vehicle are located on forward wheel support and centering assembly 56 and the rear wheel assemblies of the vehicle are located on rearward wheel support and centering assembly. Assemblies 56, 58 enable lateral centering movement of the vehicle, as well as longitudinal retention of the vehicle, for purposes of positioning the vehicle for calibration of the sensors. That is, the vehicle is positioned into a known orientation on the vehicle locating assembly 24.

Forward wheel support and centering assembly 56 includes oppositely disposed tire supports 64a, 64b positioned on opposite sides of forward vehicle centering device 66, where tire supports 64a, 64b are configured to receive the tires of a pair of opposed tire and wheel assemblies of a vehicle, such as the front wheel assemblies. Tire supports 64a, 64b are substantially identical, but mirror versions of each other. As such, the discussion herein focuses on tire support 64a, but it should be appreciated that the discussion applies to tire support 64b.

Tire support 64a includes two sets 68, 70 of rollers 72 with the rollers 72 arranged with their axes of rotation parallel with the longitudinal axis of the vehicle 25 when disposed on support stand 22. As such, a vehicle having a pair of front tires disposed on rollers 72 will be moveable laterally with respect to its longitudinal axis via the rollers 72. The sets 68, 70 of rollers 72 are inwardly angled with respect to each other. That is, the adjacently located ends of rollers 72 of each set 68, 70 are disposed vertically lower than the outwardly located ends in a V-shaped configuration. As such, the wheel assemblies of the vehicle will be naturally oriented to rest in a fixed longitudinal position when located on tire supports 64a, 64b along the axes 74a, 74b defined by the adjacent mounting ends of rollers 72. It should be appreciated that the axes 74a, 74b are arranged so as to be aligned with each other and perpendicular to rails 28a, 28b and the longitudinal axis of the vehicle when positioned on stand 22.

The vehicle is centered or positioned on support stand 22 in part via vehicle centering device 66, which is operable to center or position the forward portion of vehicle the. Vehicle centering device 66 includes a pair of opposed synchronized arms or bumpers 80a, 80b that are configured to extend outwardly from housing 82 to contact the inner sidewalls of the tires disposed on tire supports 64a, 64b. Arms 80a, 80b in particular are synchronized to move outwardly from housing 82 equally and simultaneously in opposed directions via a pair of actuators 84a, 84b that are linked together and operated by controller 152. Arm 84a is affixed to or part of plate 86a and arm 84b is affixed to or part of plate 86b, with plates 86a, 86b being slidably mounted on rails or slides 88, 90. Extendable end 92a of actuator 84a is mounted to plate 86a whereby extension of end 92a causes arm 84a to extend outwardly. Likewise, extendable end 92b of actuator 84b is mounted to plate 86b whereby extension of end 92b causes arm 84b to extend outwardly. The arms 80a, 80b are likewise retractable via retraction of ends 92a, 92b of actuators 84a, 84b. It should thus be appreciated that vehicle centering device 66 is operable to center the forward portion of vehicle 25 on vehicle support stand 22 by way of the rollers 72 allowing the vehicle to be laterally moved via equal and opposite extension of arms 80a, 80b whereby arms 80a, 80b contact and push against the inner sidewall of the tires.

Rearward wheel support and centering assembly 58 includes oppositely disposed tire supports 94a, 94b positioned on opposite sides of rearward vehicle centering device 96, where tire supports 94a, 94b are configured to receive the tires of a pair of opposed tire and wheel assemblies of vehicle 25. Tire supports 94a, 94b are substantially identical, but mirror versions of each other. As such, the discussion herein focuses on tire support 94a, but it should be appreciated that the discussion applies to tire support 94b.

Tire support 94a includes six sets 98a-98f of rollers 100 in the illustrated embodiment, with the rollers 100 arranged with their axes of rotation parallel with the longitudinal axis of the vehicle 25 when disposed on support stand 22. As such, a vehicle having a pair of rear tires disposed on rollers 100 will be moveable laterally with respect to its longitudinal axis via the rollers 100. In contrast to forward wheel support and centering assembly 56, the rollers 100 of the rearward wheel support and centering assembly 58 all lie in the same plane. The multiple sets 98a-98f of rollers 100 enable vehicles with differing wheelbases to be used on support stand 22. That is, for example, when the opposed forward wheel assemblies of vehicles are retained by tire supports 64a, 64b, the opposed rearward wheel assemblies of the vehicle can still be positioned on tire supports 94a, 94b even with differing wheelbase lengths of the vehicles.

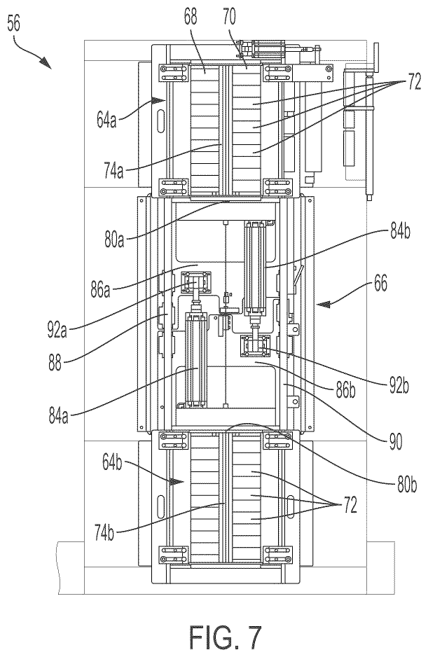

The vehicle is also centered or positioned on support stand 22 in part via rearward vehicle centering device 96, which operates in generally like manner to vehicle centering device 66 to center or position the rearward portion of the vehicle. Rearward vehicle centering device 96 includes multiple pairs of opposed and synchronized locator arms or bumpers 102a, 102b, 104a, 104b and 106a, 106b that are configured to extend outwardly from housing 108 to contact the inner sidewalls of the tires disposed on tire supports 94a, 94b. In particular, each set of opposed arms of centering device 96 are synchronized to move outwardly from housing 108 equally and simultaneously in opposed directions via actuators 110, 112, 114, 116 (FIG. 7) that are linked together and operated by controller 152. Arms 102a, 102b, 104a, 104b, 106a and 106b are slidably mounted for movement on rails or slides 118, 120, 122 and 124, whereby moveable ends 110a, 112a, 114a, 116a of actuators 110, 112, 114, 116 are able to extend and retract arms 102a, 102b, 104a, 104b, 106a and 106b relative to housing 108, including via the pulley linkages 126, 128. It should thus be appreciated that vehicle centering device 96 is operable to center the rearward portion of vehicle on vehicle support stand 22 by way of the rollers 100 allowing the vehicle to be laterally moved via equal and opposite extension of arms 102a, 102b, 104a, 104b, 106a and 106b whereby the arms contact and push against the inner sidewall of the tires. Although shown as including multiple extension arms on each lateral side for engagement with the inner sidewall of the tires, it should be appreciated that a centering system may be constructed to have a single arm on each lateral side or may have alternative numbers of arms as compared to that illustrated. Including at both the forward centering device 66 and the rearward centering device 96.

Although vehicle support stand 22 is shown in the illustrated embodiment to position, center and/or orient the vehicle 25 by arms pushing against the inner sidewall of the tires, it should be readily appreciated that an alternatively constructed centering system could be constructed in which arms or bumpers press against the outer sidewall of the tires by pushing inwardly an equal and opposite amount from the outside of the vehicle. Moreover, although tire supports 64a, 64b and 94a, 94b of system 20 are disclosed as utilizing rollers 72, 100 for lateral adjustment of vehicle 25 on support stand 22, it should be appreciated that alternative tire supports may be employed within the scope of the present invention. For example, tire supports may be constructed as floating fixtures, such as conventional float plates. This includes, for example, laterally shifting planks in lieu of rollers. Locators may be provided, such as ridges or detents, on the forward tire supports of such alternative tire supports for purposes of locating the vehicle longitudinally into a known location. For example, a pair of ridges may be provided at both of the forward tire supports that project upwardly and extend perpendicularly relative to the longitudinal axis of the support stand 22. A vehicle may then be driven onto the support stand 22 with each of the forward tire and wheel assemblies being located and/or retained between the respective pair of ridges.

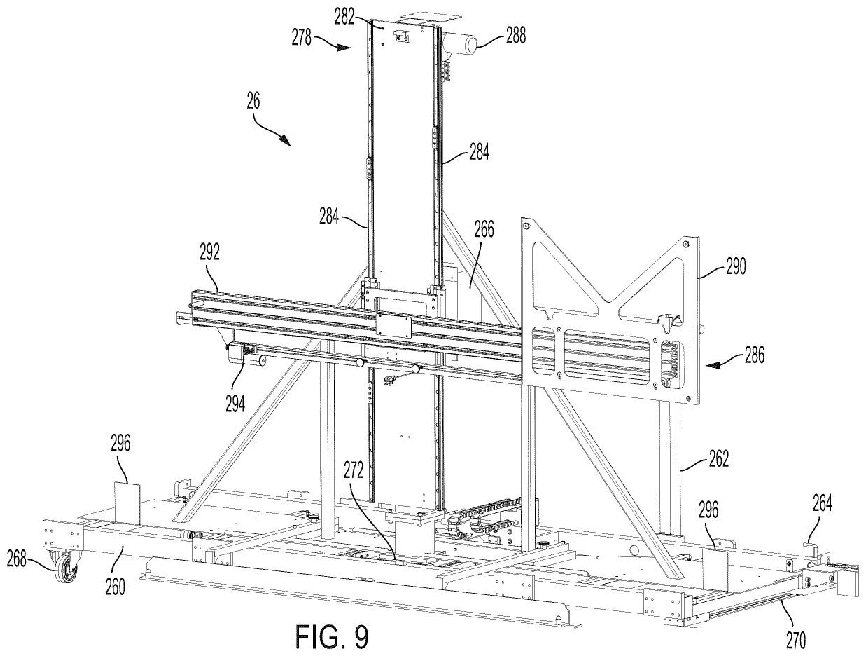

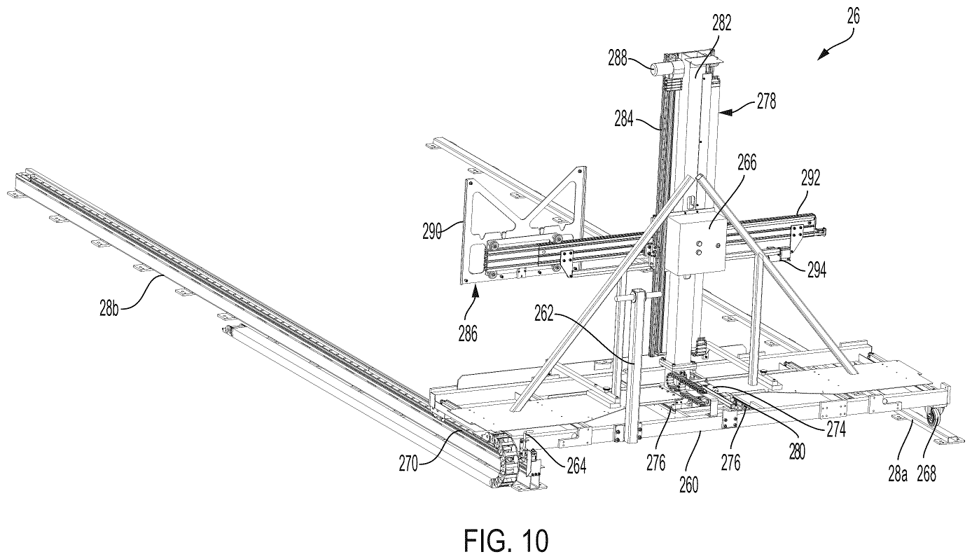

A detailed description of target frame 26 will now be provided with reference to FIGS. 9 and 10, vehicle target frame 26 is adjustable longitudinally along rails 28a, 28b to position target frame 26, and hence a target 30 mounted thereto, relative to vehicle 25 on support stand 22. In particular a base frame 260 of target frame 26 is mounted for movement along rails 28a, 28b. Target frame 26 may be both manually moveable along rails 28a, 28b via an operator pushing on handle 262, as well as automatically adjustable along rails 28a, 28b, such as via a one or more rail actuators, chain drive, pulley system or the like. Target frame 26 may additionally be secured to rails 28a,28b, such as by a manual lock 264, so as to retain base frame 260 in position, such as upon manual movement by an operator based on directions provided via controller 152.

As discussed in more detail below, in order to precisely position a target 30, target 30 on target frame 26 may additionally be moveable laterally and/or vertically and/or longitudinally with respect to the vehicle 25, as well as may also be rotationally moveable about the vertical axis.

As previously noted target adjustment frame 26 movably supports target 30 and may also include a controller 266. In the illustrated embodiment, base frame 260 of target adjustment frame 26 is generally rectangular with various frame members and includes wheels 268 for riding on rail 28a and includes a linear slide 270 for riding on rail 28b, with wheels 268 and slide 270 mounted to frame 260. Alternatively, however, base frame 260 need not include wheels 268 and/or slide 270 such as, for example, in embodiments in which base frame 260 is movable along rails 28a, 28b by a rail actuator.

Target adjustment frame 26 may further include a base member 272 that is moveable forwards and backwards via an actuator 274 along an X-axis, where base member 272 is mounted for sliding movement in rails 276 of base frame 260 and the X-axis is thus parallel to rails 276 for movement longitudinally relative to vehicle 25 on vehicle locating assembly 24.

A tower assembly 278 is mounted to base member 272. Tower assembly 278 in turn includes an upright frame member configured as a vertically oriented tower 282 with vertically oriented rails 284, with a target support assembly 286 being mounted to rails 284 whereby the assembly 286 is moveable up and down in the vertical or Z-axis, where assembly 286 is moveable by way of actuator 288. Target support assembly 286 is mounted to rails 284 for vertical movement, with a target mount 290 in turn being mounted to horizontal rail 292. Target mount 290 is configured to hold target 30 and is horizontally moveable along rail 292 by way of actuator 294, with target mount 290 including various pegs and/or cutouts for supporting targets when targets are selectively removably hung on or attached to mount 290.

Actuators 274, 280, 288 and 294 are operably connected, such as by control wires, with controller 266 whereby controller 266 is able to selectively activate the actuators to move their associated components of target adjustment frame 26. In addition, as noted above, one or more rail actuators may be employed to move the entirety of target adjustment frame 26 along rails 28a, 28b by translating movement of base frame 260 on rails 28a, 28b. It should be appreciated that various constructions or types of actuators may be used, including for actuators 274, 280, 288 and 294 for movement of the various components of target adjustment frame 26, as well as for rail actuators used to translate base frame 260 on rails 28a, 28b. In the illustrated embodiment, actuators 274, 280, 288 and 294 are constructed as electrical linear actuators. Alternatively, however, the actuators may be constructed as geared tracks, adjustment screws, hydraulic or pneumatic piston actuators, or the like. Still further, it should be appreciated that alternative arrangements of target adjustment frame and actuators may be employed for positioning of a target within the scope of the present invention. For example, base member 272 may be configured for lateral movement relative to base frame 260 and/or tower 278 may be configured for lateral movement relative to base member 272. Moreover, to the extent base frame 260 may be sufficiently precisely positioned longitudinally along rails 28a, 28b with rail actuators, system 20 may need not include actuator 272 and rails 276 for providing fine adjustment of the lateral position of base member 272 along rails 276.

System 20 may additionally include distance sensors, such as time-of-flight sensors, for monitoring and/or controlling the distance of target frame 26 to support stand 22. In the illustrated embodiment, laterally separated plates 296 may be provided on base frame 260 for use with distance sensors configured as time-of-flight (“ToF”) sensors on support stand 22. The distance information may be used as a feedback loop in setting the target position relative to the vehicle.

Alternatively, as shown in FIG. 11, a robot or robotic target manipulator 300 may be used to hold a target 30, such as disclosed in U.S. Pat. No. 11,597,091. The robot 300 includes a multi-axis arm 300a along with a gripper 302 for holding the target 30, with the robot 300 also including a base 304 that is moveable along track 306 for longitudinally adjusting the distance of the robot 300 relative to the vehicle 25. In particular, with the vehicle 25 fixed on vehicle locating assembly 24, the robot 300 is able to manipulate the target 30 into the appropriate position for calibrating the sensor 25a.

Changes and modifications in the specifically described embodiments can be carried out without departing from the principles of the present invention which is intended to be limited only by the scope of the appended claims, as interpreted according to the principles of patent law including the doctrine of equivalents.

1. A sensor target system for aligning sensors equipped on a vehicle with calibration targets, said system comprising:
a vehicle support stand configured to selectively hold a vehicle;
a moveable web having a plurality of targets disposed thereon, wherein said moveable web is disposed adjacent said vehicle support stand such that said targets are oriented to face upwards; and
wherein said web is moveable to selectively position one of said targets into a preselected position for calibration of a sensor of a vehicle on said vehicle support stand.

2. The sensor target system of claim 1, further comprising a pair of reels about which said web is disposed with a planar section of said web spanning between said reels, wherein said reels are selectively rotated for movement of said web.

3. The sensor target system of claim 2, wherein said web is configured to be selectively unwound from one said reel and wound on the other said reel for movement in one direction.

4. The sensor target system of claim 2, further comprising at least one encoder associated with at least one of said reels for monitoring the rotation of said at least one reel.

5. The sensor target system of claim 1, wherein said web is horizontally oriented.

6. The sensor target system of claim 1, wherein said web is moveable in a longitudinal direction relative to a vehicle disposed on said vehicle support stand.

7. The sensor target system of claim 1, wherein said web is moveable in a lateral direction relative to a longitudinal direction of a vehicle disposed on said vehicle support stand.

8. The sensor target system of claim 1, wherein said web is supported by at least one actuator for movement of said web relative to said vehicle support stand.

9. The sensor target system of claim 8, wherein said web has an elongate length and wherein said at least one actuator is configured to move said web perpendicularly relative to said elongate length.

10. The sensor target system of claim 1, wherein said web comprises a first web having an elongate length with said first web being disposed such that said elongate length of said first web extends parallel to a longitudinal axis of a vehicle disposed on said vehicle support stand.

11. The sensor target system of claim 10, further comprising a second web, wherein said second web comprises a moveable web having a plurality of targets disposed thereon, wherein said second web is disposed adjacent said vehicle support stand such that said targets are oriented to face upwards; and
wherein said second web is moveable to selectively position one of said targets into a preselected position for calibration of a sensor of a vehicle on said vehicle support stand; and
wherein said second web has an elongate length with said second web being disposed such that said elongate length of said second web extends parallel to the longitudinal axis of the vehicle disposed on said vehicle support stand on an opposite side from said first web.

12. The system of claim 11, wherein said vehicle support stand comprises a vehicle positioning assembly for orienting a vehicle into a known orientation on said vehicle support stand.

13. The system of claim 1, further comprising a moveable target adjustment frame positioned forward of said vehicle support stand, with said target adjustment frame configured to hold another target and comprising a rail for longitudinal movement of said target adjustment frame toward and away from the vehicle disposed on said support stand.

14. The system of claim 1, further comprising a moveable robot configured to hold another target and being positioned forward of said vehicle support stand, and comprising a track along which said robot is configured to move toward and away from the vehicle disposed on said support stand.

15. A method for aligning a target to a sensor on an equipped vehicle, said method comprising:
positioning a vehicle into a known orientation;
moving an upwardly oriented selected target into a calibration position adjacent the vehicle, wherein the selected target is disposed on a web of a plurality of targets.

16. The method of claim 15, wherein the web is disposed on a pair of reels and wherein said moving comprises rotating said reels to position the selected target into the calibration position.

17. The method of claim 16, wherein said moving comprises moving the web in a given direction by winding the web onto one of the reels and unwinding the web from the other of the reels.

18. The method of claim 15, wherein the web is supported by a linear actuator and wherein said moving comprises moving the web via the linear actuator.

19. The method of claim 15, further comprising laterally moving the web relative to a longitudinal axis of the vehicle for positioning the selected target into the calibration position.

20. The method of claim 19, wherein said positioning the vehicle into the known orientation comprises positioning the vehicle on a vehicle support stand.
